(19) United States
(12) Patent Application Publication
(10) Pub. No.: US 2004/0027608 A1
(43) Pub. Date: Feb. 12, 2004

(54) Image print method, image print system, image delivery method and image delivery system

(75) Inventor: Naoto Kinjo, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/388,599

(22) Filed: Mar. 17, 2003

(30) Foreign Application Priority Data
Mar. 15, 2002 (JP) 2002-071928

(51) Int. Cl. G06K 1/00; G06F 15/00; H04N 1/23

(52) U.S. Cl. 358/1.15; 358/402; 358/302

(57) ABSTRACT

The image print method performs image processing on image data acquired, in accordance with information on the image processing based on a request from a customer, sends the image data subjected to the image processing to a periodic distribution center which distributes a plurality of periodic deliveries via communication circuits together with information on an image destination based on the request from the customer, and outputs on a sheet a print image corresponding to the processed image data sent to the periodic distribution center as part of a periodic delivery destined for a destination conforming to the image destination specified by the information on the image destination based on the request from the customer or as an accompaniment for the periodic delivery.

### BACKGROUND OF THE INVENTION

This invention relates to an image print method and an image print system as well as an image delivery method and an image delivery system used to supply an image to a desired destination.

Today, it is possible to acquire a printed image (hereinafter simply referred to as a print image) as a photographic print (finished print) by bringing a silver halide film exposed using a camera to a photofinishing service shop in order to ask development and printing of the film. It is also possible to acquire image data by shooting an image by using a digital still camera and acquire a print image as a photographic print via a printer.

Transmission scanners to read films and reflection scanners to read original images printed on paper are also in widespread use for personal users. Thus, it is possible to photoelectrically capture on a transmission scanner an image from a negative film exposed using a conventional camera for silver halide films thereby acquiring the captured image as image data. It is also possible to photoelectrically capture on a reflection scanner an original image already printed and acquire the captured image as image data. Thereafter, it is possible to acquire a print image, same as image data acquired using a digital still camera.

With widespread use of a communications unit such as a personal computer (hereinafter simply referred to as a PC) connected to a communications network (communication circuits) including the Internet, it is possible to readily acquire image data via the Internet. The image data thus captured is used as an image to be appreciated on an image display unit such as a CRT and an LCD (hereinafter referred to as a display) connected to a PC. The acquired image (image data) is supplied to an image output unit such as an ink-jet printer and a laser printer (hereinafter referred to as a printer) connected as a peripheral unit to a PC so as to output the image as a color or monochrome print image, in other words, printed matter (print) on which a color or monochrome image is reproduced.

To carry out such an image print method, it is necessary to purchase peripheral units such as a PC and a printer and application software for image processing. The above image print method is likely to be given a wide berth as a cumbersome procedure by customers, especially people in late middle age and the youth, who cannot get accustomed to or is not good at operating a PC.

For these customers, a medium for recording image data such as SmartMedia(TM), FlashCard(TM) or Memory Stick(TM) onto which image data of an image obtained by shooting with a digital still camera (DSC) is stored is passed to a photofinishing laboratory shop, which provides a service to print out a shot image as a print image. Further, when image data is sent to a photofinishing laboratory shop from a PC via a communications network such as the Internet, a service is provided where the photofinishing laboratory shop outputs a print image from the image data sent.

Even when a customer uses such a service, he/she must visit the photofinishing laboratory shop to receive the printed image or have the print image delivered by mail from the photofinishing laboratory shop.

If a PC having image data stored therein is connected to an ink-jet printer, an image (print image) corresponding to the image data can be printed on paper and output on the side of a customer, for example at the customer's home and a print on which the image is reproduced can be thus readily obtained. However, the thus output print image suffers from unsatisfactory image quality. Even if commercially available color ink for ink-jet printers dedicated to photographs and commercially available ink-jet print paper dedicated to photographs are used to output a print image with a customer's ink-jet printer, the resulting print image suffers from unsatisfactory image quality compared with a print image on a silver halide photosensitive material (photographic paper) already on the market.

In order to attain a certain level of image quality of an output image in an ink-jet printer, it is necessary to use the dedicated color ink and print paper described above and grade up the model of ink-jet printer. However, the high-grade model is expensive, which increases the costs for acquiring a print image concomitantly with the use of the dedicated color ink and print paper. A customer must bear higher costs as the print size of the print image becomes larger. The maximum paper size output by a general ink-jet printer on the market is A3. Printout in larger paper is only available on a more expensive business-grade printer.

There is also a case where high-grade models of inkjet printers are only intended for business use and people cannot purchase them for personal use.

Therefore, even in a print image to be output from an ink-jet printer, in order to acquire the print image with a certain level of satisfaction, a request must be made to a specialized laboratory for print output, and upon receipt of the print image, it is necessary to visit the specialized laboratory for directly receiving the print image or request the specialized laboratory to deliver it by mail.

If a customer who is proficient in operation of a PC, for example in the rising generation or in the middle-aged generation, wishes to deliver an image to a customer who is a computer-illiterate, for example in late middle age, he/she must use delivery means such as the mail service to deliver the output print image (namely print or printed matter on which the image is reproduced), not a communications network.

### SUMMARY OF THE INVENTION

The invention has been accomplished under these circumstances and aims at providing an image print method which can supply a low-cost print image to a desired destination while using communication circuits.

A second object of the present invention is to provide an image print system in which the image print method is implemented.

A third object of the present invention is to provide an image delivery method which allows preventing misdelivery and assisting in the delivery work so as to carry out smooth delivery.

A fourth object of the present invention is to provide an image delivery system in which the image delivery method is implemented.

In order to attain the objects described above, the first aspect of the present invention provides an image print method comprising:

an image processing step of performing image processing on image data acquired, in accordance with information on the image processing based on a request from a customer;

an image sending step of sending the image data subjected to the image processing to a periodic distribution center which distributes a plurality of periodic deliveries via communication circuits together with information on an image destination based on the request from the customer; and

a print image outputting step of outputting on a sheet a print image corresponding to the processed image data sent to the periodic distribution center as part of a periodic delivery destined for a destination conforming to the image destination specified by the information on the image destination based on the request from the customer or as an accompaniment for the periodic delivery.

Preferably, the request from the customer is destined for an image processing center equipped with an image processor connected via the communication circuits.

Preferably, the image data acquired by the image processor is at least one of image data provided together with the request from the customer, image data acquired by reading image provided together with the request from the customer, and image data downloaded from a network connected via the communication circuits in accordance with an instruction from the customer.

Further, preferably, the periodic delivery is printed matter regularly delivered from the periodic distribution center to the destination.

Preferably, the sheet where the print image is output or the periodic delivery is provided with destination identifying means having image destination information specified by the information on the image destination based on the request from the customer.

Preferably, the destination identifying means is an IC (integrated circuit) tag which stores the image destination information.

In order to attain the objects described above, the second aspect of the present invention provides an image print system comprising an image processor and an output printer which are interconnected via communication circuits,

wherein the image processor performs image processing on image data acquired, in accordance with information on the image processing based on a request from a customer and sends the image data subjected to the image processing to the output printer installed in a periodic distribution center which distributes a plurality of periodic deliveries together with information on an image destination based on the request from the customer and

wherein the output printer outputs on a sheet a print image corresponding to the image data received from the image processor after the image processing has been performed, as part of a periodic delivery destined for a destination conforming to the image destination specified by the information on the image destination based on the request from the customer or as an accompaniment for the periodic delivery.

Preferably, the image data acquired by the image processor is at least one of image data provided together with the request from the customer, read image data acquired by reading an original image provided together with the request from the customer, and image data downloaded from a network connected via the communication circuits in accordance with an instruction from the customer.

And, preferably, the image processor is installed in an image processing center and the request from the customer is destined for the image processing center.

Further, preferably, the periodic delivery is printed matter regularly delivered from the periodic distribution center to the destination.

Preferably, the sheet where the print image is output or the periodic delivery is provided with destination identifying means having image destination information specified by the information on the image destination based on the request from the customer.

Preferably, the destination identifying means is an IC (integrated circuit) tag which stores the image destination information.

In order to attain the objects described above, the third aspect of the present invention provides an image delivery method by which a print image output by the image print method according to the first aspect described above is delivered to a destination of a periodic delivery conforming to an image destination specified by information on the image destination based on a request from a customer as part of the periodic delivery destined for the destination or as an accompaniment for the periodic delivery,

wherein the image print method comprises:

an image processing step of performing image processing on image data acquired, in accordance with information on the image processing based on the request from the customer;

an image sending step of sending the image data subjected to the image processing to a periodic distribution center which distributes a plurality of periodic deliveries via communication circuits together with the information on the image destination based on the request from the customer; and

a print image outputting step of outputting on a sheet the print image corresponding to the processed image data sent to the periodic distribution center as the part of the periodic delivery destined for the destination or as the accompaniment for the periodic delivery,

the image delivery method, comprising:

a step of providing a light-emitting device at an end of a first IC tag which is attached to the sheet having the print image output thereon or to the periodic delivery including the sheet as the part thereof or as the accompaniment therefor, and which has image destination information specified by the information on the image destination based on the request from the customer;

a step of setting an identification number of the first IC tag and the destination in a navigation system mounted on or on board of a vehicle for use in distributing the plurality of periodic deliveries from the periodic distribution center to a plurality of destinations or to onboard equipment with a GPS (Global Positioning System) function possessed by a carrier distributing the plurality of periodic deliveries;

a step of transmitting a light emission signal for allowing the first IC tag to emit light in accordance with the set identification number from the navigation system or the onboard equipment with the GPS function to the plurality of periodic deliveries when the vehicle or the carrier arrives at the destination making use of the navigation system or the onboard equipment with the GPS function; and

a step of allowing the light-emitting device of the first IC tag which has an identification number conforming to the set identification number to emit light.

Furthermore, in order to attain the objects described above, the third aspect of the present invention provides an image delivery method by which a print image output by the image print method according to the first aspect described above is delivered to a destination of a periodic delivery conforming to an image destination specified by information on the image destination based on a request from a customer as part of the periodic delivery destined for the destination or as an accompaniment for the periodic delivery,

wherein the image print method comprises:

an image processing step of performing image processing on image data acquired, in accordance with information on the image processing based on the request from the customer;

an image sending step of sending the image data subjected to the image processing to a periodic distribution center which distributes a plurality of periodic deliveries via communication circuits together with the information on the image destination based on the request from the customer; and

a print image outputting step of outputting on a sheet the print image corresponding to the processed image data sent to the periodic distribution center as the part of the periodic delivery destined for the destination or as the accompaniment for the periodic delivery,

the image delivery method, comprising:

a step of providing a light-emitting device at an end of a first IC tag which is attached to the sheet having the print image output thereon or to the periodic delivery including this sheet as the part thereof or as the accompaniment therefor, and which has image destination information specified by the information on the image destination based on the request from the customer;

a step of attaching to a receiver of the periodic delivery in the destination, a second IC tag in which information on the destination is stored;

a step of reading the information on the destination stored in the second IC tag by onboard equipment possessed by a carrier and having an IC tag reader function of reading information stored in an IC tag, when the carrier distributing the plurality of periodic deliveries from the periodic distribution center to a plurality of destinations, thereby transmitting a light emission signal for allowing the first IC tag to emit light from the onboard equipment to the plurality of periodic deliveries in accordance with the information on the destination read by the onboard equipment; and

a step of allowing the light-emitting device of the first IC tag which has the image destination information conforming to the information on the destination to emit light.

Furthermore, in order to attain the objects described above, the thirst aspect of the present invention provides an image delivery method by which a print image output by the image print method according to the first aspect described above is delivered to a destination of a periodic delivery conforming to an image destination specified by information on the image destination based on a request from a customer as part of the periodic delivery destined for the destination or as an accompaniment for the periodic delivery,

wherein the image print method comprises:

an image processing step of performing image processing on image data acquired, in accordance with information on the image processing based on the request from the customer;

an image sending step of sending the image data subjected to the image processing to a periodic distribution center which distributes a plurality of periodic deliveries via communication circuits together with the information on the image destination based on the request from the customer; and

a print image outputting step of outputting on a sheet the print image corresponding to the processed image data sent to the periodic distribution center as the part of the periodic delivery destined for the destination or as the accompaniment for the periodic delivery,

the image delivery method, comprising:

a step of attaching to a receiver of the periodic delivery in the destination, an IC tag reader which reads information stored in an IC tag and in which the information on the destination is set;

a step of reading with the IC tag reader, image destination information stored in a first IC tag which is attached to the periodic delivery to be distributed to the destination or to the sheet which is distributed as the part of or the accompaniment for the periodic delivery and on which the print image is output, and which has the image destination information specified by the information on the image destination based on the request from the customer; and

a step of announcing inconformity by voice or visual display when the information on the destination set by the IC tag reader does not conform to the image destination information that the IC tag reader read from the first IC tag.

In order to attain the objects described above, the fourth aspect of the present invention provides an image delivery system which delivers a print image output by the image print system according to the second aspect described above to a destination of a periodic delivery conforming to an image destination specified by information on an image destination based on a request from a customer as part of the periodic delivery destined for the destination or as an accompaniment for the periodic delivery, comprising:

an image print system for outputting the print image, the image print system comprising an image processor and an output printer which are interconnected via communication circuits, wherein the image processor performs image processing on image data acquired, in accordance with the information on the image processing based on the request from the customer and sends the image data subjected to the image processing to the output printer installed in a periodic distribution center which distributes a plurality of periodic deliveries together with the information on the image destination based on the request from the customer, and wherein the output printer outputs on a sheet the print image corresponding to the image data received from the image processor after the image processing has been performed, as the part of the periodic delivery destined for the destination or as the accompaniment for the periodic delivery;

a first IC tag which is attached to the sheet having the print image output thereon or to the periodic delivery including the sheet as the part thereof or as the accompaniment therefor, which has image destination information specified by the information on the image destination based on the request from the customer and which has a light-emitting device attached to an end thereof; and

a navigation system mounted on or on board of a vehicle for distributing the plurality of periodic deliveries from the periodic distribution center to a plurality of destinations or onboard equipment with a GPS function that a carrier distributing the plurality of periodic deliveries possesses, the navigation system or the onboard equipment previously setting an identification number of the first IC tag and the destination,

wherein, when the vehicle or the carrier arrives at the destination making use of the navigation system or the onboard equipment, a light emission signal for allowing the first IC tag to emit light is transmitted in accordance with the set identification number from the navigation system or the onboard equipment to the plurality of periodic deliveries, whereby the light-emitting device of the first IC tag whose identification number conforms to the set identification number emits light.

Furthermore, in order to attain the objects described above, the fourth aspect of the present invention provides an image delivery system which delivers a print image output by the image print system according to the second aspect described above to a destination of a periodic delivery conforming to an image destination specified by information on an image destination based on a request from a customer as part of the periodic delivery destined for the destination or as an accompaniment for the periodic delivery, comprising:

an image print system for outputting the print image, the image print system comprising an image processor and an output printer which are interconnected via communication circuits, wherein the image processor performs image processing on image data acquired, in accordance with the information on the image processing based on the request from the customer and sends the image data subjected to the image processing to the output printer installed in a periodic distribution center which distributes a plurality of periodic deliveries together with the information on the image destination based on the request from the customer, and wherein the output printer outputs on a sheet the print image corresponding to the image data received from the image processor after the image processing has been performed, as the part of the periodic delivery destined for the destination or as the accompaniment for the periodic delivery;

a first IC tag which is attached to the sheet having the print image output thereon or to the periodic delivery including the sheet as the part thereof or as the accompaniment therefor, which has image destination information specified by the information on the image destination based on the request from the customer and which has a light-emitting device attached to an end thereof;

a second IC tag which is attached to a receiver of the periodic delivery in the destination and in which the information on the destination is stored; and

onboard equipment possessed by a carrier and having an IC tag reader function of reading information stored in an IC tag when the carrier distributing the plurality of periodic deliveries from the periodic distribution center to a plurality of destinations,

wherein the information on the destination stored in the second IC tag is read,

wherein a light emission signal for allowing the first IC tag to emit light is transmitted from the onboard equipment to the plurality of periodic deliveries in accordance with the information on the destination read by the onboard equipment, and

wherein the light-emitting device of the first IC tag having the image destination information conforming to the read information on the destination is allowed to emit light.

Furthermore, in order to attain the objects described above, the fourth aspect of the present invention provides an image delivery system which delivers a print image output by the image print system according to the second aspect described above to a destination of a periodic delivery conforming to an image destination specified by information on an image destination based on a request from a customer as part of the periodic delivery destined for the destination or as an accompaniment for the periodic delivery, comprising:

an image print system for outputting the print image, the image print system comprising an image processor and an output printer which are interconnected via communication circuits, wherein the image processor performs image processing on image data acquired, in accordance with the information on the image processing based on the request from the customer and sends the image data subjected to the image processing to the output printer installed in a periodic distribution center which distributes a plurality of periodic deliveries together with the information on the image destination based on the request from the customer, and wherein the output printer outputs on a sheet the print image corresponding to the image data received from the image processor after the image processing has been performed, as the part of the periodic delivery destined for the destination or as the accompaniment for the periodic delivery;

a first IC tag which is attached to the sheet having the print image output thereon or to the periodic delivery including the sheet as the part thereof or as the accompaniment therefor and which has image destination information specified by the information on the image destination based on the request from the customer; and

an IC tag reader which is placed on a receiver of the periodic delivery in the destination, which reads information stored in an IC tag and which sets the information on the destination,

wherein, when a carrier distributing the plurality of periodic deliveries from the periodic distribution center to a plurality of destinations arrives at the destination, the IC tag reader is used to read the information on the destination stored in the first IC tag which is attached to the periodic delivery to be distributed to the destination or to the sheet which is distributed as the part of or the accompaniment for the periodic delivery and on which the print image is output, and

wherein inconformity is announced by voice or visual display when the information on the destination set by the IC tag reader does not conform to the image destination information that the IC tag reader read from the first IC tag.

In the present invention, a print image means an image reproduced on a sheet by using an image data or a print on a sheet reproducing an image corresponding to an image data.

### BRIEF DESCRIPTION OF THE DRAWINGS

FIG. 1 is a conceptual illustration explaining an embodiment of an image delivery system including an image print system of the invention;

FIG. 2 is a conceptual illustration showing an example of a digital photo printer used in the image print system of the invention;

FIG. 3 is a flowchart of an embodiment of an image print method of the invention;

FIG. 4 explains the template for image-related information used in the image print system of the invention;

FIG. 5 shows an example of a print image output from the image print system of the invention;

FIG. 6 is a conceptual illustration explaining an embodiment of an image delivery method of the invention;

FIG. 7 is a conceptual illustration explaining another embodiment of the image delivery method of the invention; and

FIG. 8 is a conceptual illustration explaining yet another embodiment of the image delivery method of the invention.

### DETAILED DESCRIPTION OF THE INVENTION

The image print method, the image print system, the image delivery method and the image delivery system according to the invention are described below in detail with reference to preferred embodiments shown in the accompanying drawings.

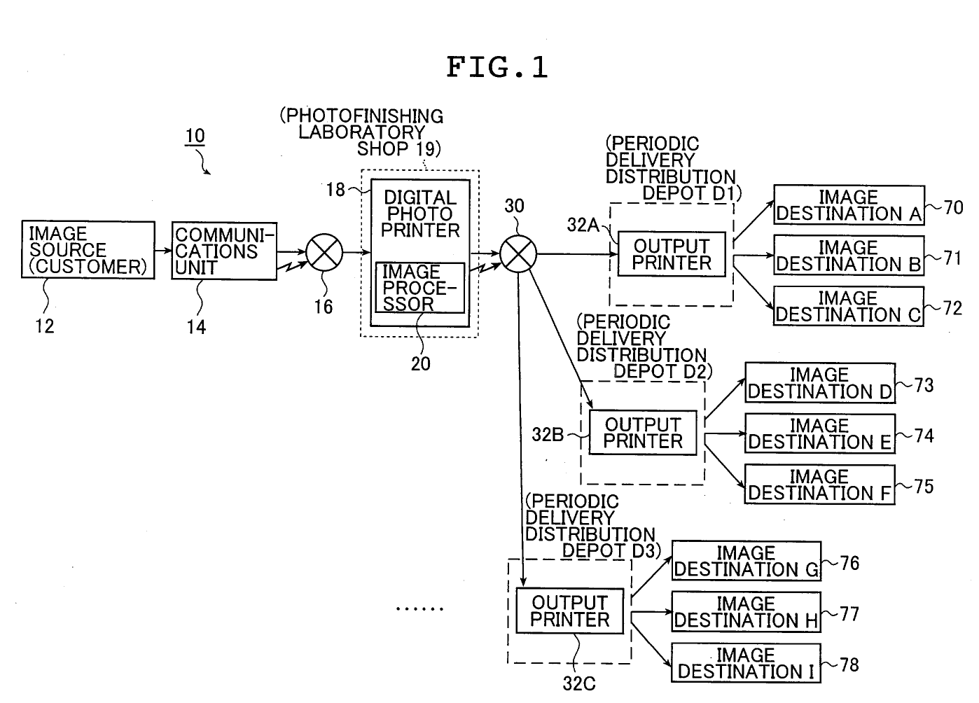

FIG. 1 is a conceptual illustration explaining an embodiment of an image delivery system that includes an image print system for implementing an image delivery method in which an image print method of the present invention is utilized.

As shown in FIG. 1, the image delivery system 10 receives from an image source (customer) 12 a request for an image supply service to supply an image to desired image destinations 70 through 78 and performs the service. The image delivery system 10 comprises a communications unit 14, a digital photo printer 18 equipped with an image processor 20 for processing image data acquired at the request of the image source 12, and a plurality of periodic delivery distribution depots D1, D2 and D3 respectively including output printers 32A, 32B and 32C for outputting as a print image data which has undergone image processing and is sent from the digital photo printer 18. The digital photo printer 18 is installed in a so-called photofinishing laboratory shop 19 (image processing center).

The communications unit 14 and the digital photo printer 18 are interconnected via a communications network 16 such as the Internet, LAN (Local Area Network), WAN (Wide Area Network), or MAN (Metropolitan Area Network).

The digital photo printer 18 and the output printers 32A, 32B and 32C are similarly interconnected via a communications network 30. The communications network 16 and the communications network 30 may be the same network or different networks.

The communications unit 14 comprises a PC equipped with a modem capability or a terminal adapter capability, a PDA (Personal Digital Assistant) or a cell phone having a capability of connecting to a communications network.

The digital photo printer 18 comprises an image processor 20 which acquires image data requested by the communications unit 14 and performs processing such as image processing on the image data at the request.

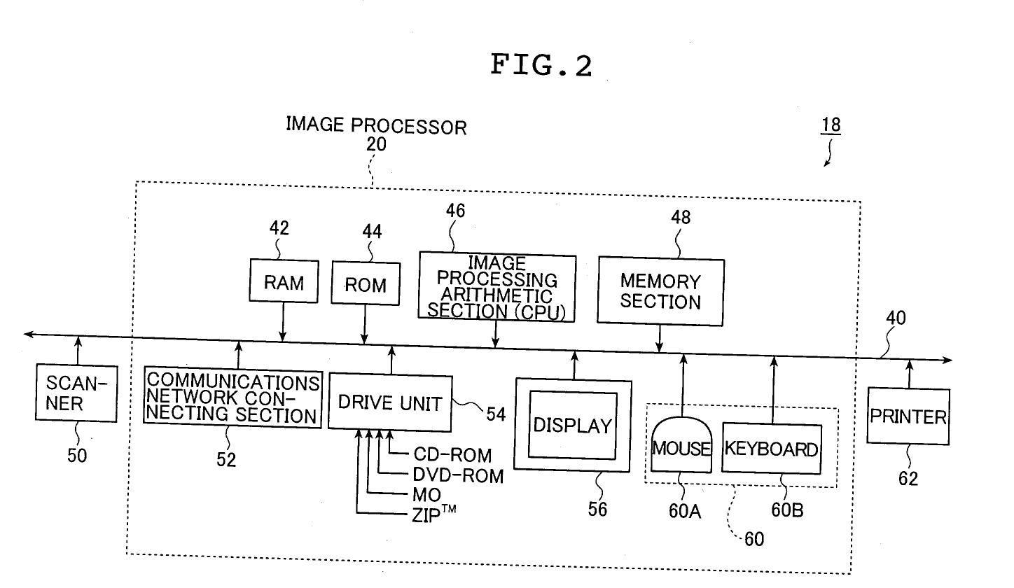

To the image delivery system 10 are connected periodic delivery distribution depots D1, D2 and D3 comprising the output printers 32A, 32B and 32C. This is because a periodic delivery distribution depot closest to the address of an image destination requested by the image source 12 is selected. The number of the output printers, periodic delivery distribution depots, or image destinations may be different from that shown in FIG. 1 and may be one or two (one or more locations) or four or more (four or more locations). In the following description of the embodiments of the image delivery system 10, a periodic delivery distribution depot D1 is chosen as a representative example of a periodic delivery distribution depot closest to the address of the image destination from the periodic delivery distribution depots D1 through D3, FIG. 2 is a block diagram showing the general configuration of an example of the digital photo printer 18. The section enclosed by dashed lines is a block diagram showing the general configuration of the image processor 20 of the digital photo printer 18. As shown in FIG. 2, the components of the digital photo printer 18 are interconnected by a common bus 40.

The digital photo printer 18 comprises the image processor 20, a scanner 50 for reading an image shot on a film, and a printer 62 for printing a processed image which has undergone desired image processing. The printer 62 is an image output unit which outputs a print image at a request of a customer or prints a test print image before sending a print image to an image destination. The printer may be a photosensitive printer to use recording paper of a photosensitive material, ink-jet printer or laser printer, and preferably supports color output.

The scanner 50 is image read means for photoelectrically reading an image on a CCD (Charge Coupled Device) when the image source 12 has brought an acquired image directly to the photofinishing laboratory shop 19 (see FIG. 1) without using the communications unit 14.

The image processor 20 comprises a RAM (Random Access Memory) 42, a ROM (Read Only Memory) 44, an image processing arithmetic section 46 including a CPU (Central Processing Unit), a memory section 48, a communications network connecting section 52, a drive unit (storage section) 54, a display 56, and a data input section 60 including a mouse 60A and a keyboard 60B.

The RAM 42 is temporary storage means having an area where image processing arithmetic operation is done by a program stored in the ROM 44. The RAM 42 is also a storage area used as a VRAM (Video Random Access Memory) for displaying an image in color on the display 56.

The ROM 44 is storage means for storing in advance programs mandatory for image processing arithmetic operation and image processing.

The image processing arithmetic section 46 is arithmetic operation means for issuing an operation instruction to each component of the digital photo printer 18 and performing arithmetic operation necessary for image processing in executing the image processing.

The memory section 48 is storage means for storing image data and image-related information sent from the communications unit 14 of a customer.

The communications network connecting section 52 is connected to the communications networks 16 and 30 (see FIG. 1) such as the Internet and has a modem or terminal adapter capability. The communications network connecting section 52 is means for receiving image data sent from the communications unit 14 or sending image data from the digital photo printer 18 to the output printer 32A.

As shown in FIG. 2, the drive unit 54 is a storage section for driving an image data recording medium such as a CD-ROM, DVD-ROM, MO and ZIP(TM) and stores image data and image-related information onto these recording media.

The display 56 is image display means for displaying an acquired image sent from an image source and a processed image which has undergone image processing.

The mouse 60A in the data input section 60 is a pointing device for specifying with a click for example an icon of image processing type and other icons.

The keyboard 60B is command and data input means for inputting a command necessary for operating the digital photo printer 18 (FIGS. 1 and 2) and a command, text and numerical values necessary for communicating image data.

The digital photo printer 18 thus configured is connected through the communications network connecting section 52 via the communications network 30 to the output printer 32A, 32B or 32C.

The output printer 32A, 32B or 32C is means for printing a processed image sent as a print image of a desired size. The output printer 32A, 32B or 32C may be a printer of a known system such as an ink-jet printer, thermal printer, or photosensitive printer.

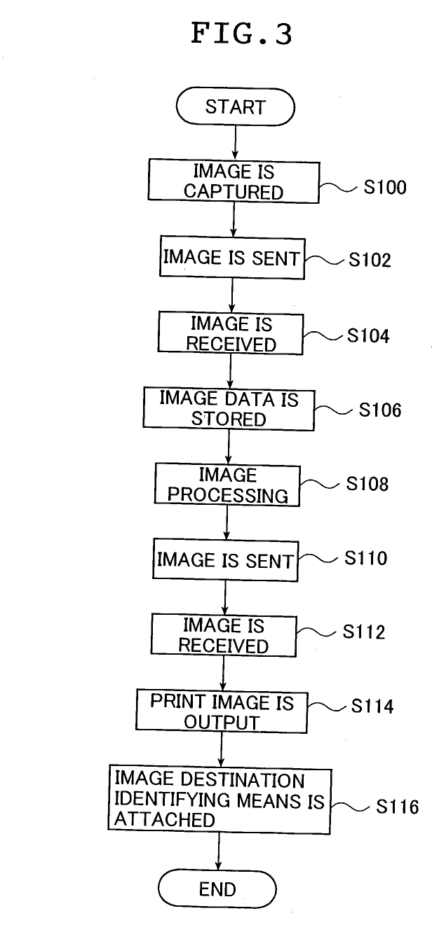

Next, the image print method of the invention is described below with reference to FIG. 3.

At the image source 12, a desired image is captured (step 100). The image capture method may be a method where the image of a subject is captured as a digital image data on a digital still camera (hereinafter referred to as captured image data), a method where a print image is read with a CCD on a reflection scanner and the read image is captured as digital image data, a method where an image shot on a silver halide film using a transmission scanner is similarly read and captured as digital image data, or a method where Internet connection is provided by using a PC, PDA or a cell phone having a communications capability and an image of a home page on the Internet is captured as digital image data, or one of the other various methods.

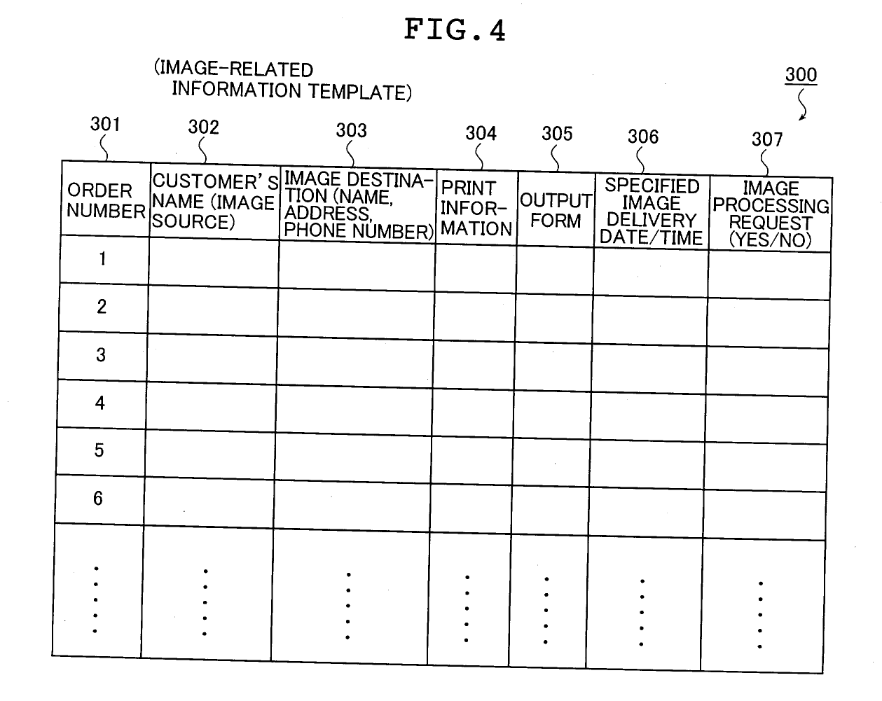

The captured image data is sent, together with an image-related information template (spreadsheet) 300 previously acquired (FIG. 4) which is described later, to the digital photo printer 18 installed in the photofinishing laboratory shop 19 via a modem or terminal adapter (not shown) and the communications network 16 such as the Internet (step 102). In this practice, the captured image data may be sent to the communications network 16 by using a radio communications unit such as a cell phone. The captured image data thus sent from the image source 12 is acquired by the digital photo printer 18.

Referring to FIG. 4, the aforementioned image-related information template 300 is described below. The template 300 provides, in a single field of a database format, the items for inputting an “order number” 301, a “customer's name (image source)” 302, an “image destination” 303, “print information” 304, an “output form” 305, a “specified image delivery date/time” 306, and an “image processing request (Y/N)” 307. To each column (cell) is input necessary information using a keyboard 60B before image transmission (step 102). It is thus possible to use the template 300 to readily input necessary image-related information such as “who” (image source column 302), “when” (column 306 to specify the image delivery date and morning or evening paper), “where” (image destination column 303), “what” (print information column 304 to specify the print size and paper type), and “how” (output form column 305 and image processing request column 307 to specify the type of image processing, number of images and image output form as described later) without any omissions. The template 300 also serves as a purchase order form used by the image source 12 to the photofinishing laboratory shop 19.

In the photofinishing laboratory shop 19, acquired image data and image-related information are received by the digital photo printer 18 via a communications network connecting section 52 (FIG. 2) (step 104) and the acquired image data is stored into the memory section 48 (step 106). The acquired image data is generally voluminous, so that a PC server equipped with a large-capacity storage section is preferably provided in order to support requests from a large number of image sources. The image data is preferably stored onto a recording medium such as a CD-ROM provided in the drive unit 54. When an image is received (step 104), an acquired image received and acquired (hereinafter referred to as an acquired image) is displayed on the screen of the display 56 together with image-related information.

Here, desired image processing is executed on the acquired image data stored into the memory section 48 by using the image processing arithmetic section 46 of the image processor 20, based on the request details of the image source 12 on the image-related information template 300 (FIG. 4) (step 108). In this practice, a program necessary for arithmetic operation for image processing is fetched from the ROM 44 and executed by way of an instruction from the CPU of the image processing arithmetic section 46. The RAM 42 is used as required as an arithmetic operation processing area (working memory). These image processing types can be updated, added or modified as required by installing new processing software from the drive unit 54. Image processing includes color balance adjustment, contract adjustment, brightness compensation, sharpness processing, gamma compensation, dodging, back-light compensation, red-eye compensation, aberration compensation of objective lens, chromatic aberration compensation, underexposure compensation, overexposure compensation, free trimming, and monotone finish (including sepia finish).

Next, processed image data which has undergone image processing is sent, together with the image-related information described above, to the periodic delivery distribution depot D1 for distributing periodic delivery to the addresses of the image destinations 70 through 72 or their neighborhood from the digital photo printer 18 of the photofinishing laboratory shop 19 (step 110). In this embodiment, the targets of distribution of the periodic delivery distribution depot D1 are a newspaper and a foldout sheet put between the leaves of the newspaper, and the periodic delivery distribution depot D1 is a newspaper distribution depot D1.

It is preferable that the photofinishing laboratory shop 19 holds a database on the distribution depots D1 in all parts of the country or accesses the outside database to find out the closest distribution depot D1 from the telephone numbers or addresses of the image destinations 70 through 72. In this practice, a plurality of distribution depots D1 to which priorities are assigned may be selected. Alternatively, a plurality of delivery companies to which priorities are assigned can also be selected. For example, priorities can be assigned in increasing order of delivery time and/or in increasing order of charge involved.

In this case, the newspaper distribution depot D1 at the destination is automatically set as a destination of image data from the data in the image destination column 303 of the image-related information template 300 (see FIG. 4). After that, the image data which has undergone image processing is sent to the automatically set newspaper distribution depot D1 (step 110). In the newspaper distribution depot D1, this image data is received by a PC via a modem or a terminal adapter (step 112).

Here, it is preferable that a PC server (not shown) capable of storing large-capacity data is deployed in the newspaper distribution depot D1 and the received image data is stored in the large-capacity PC server. Further, the newspaper distribution depot D1 is equipped with a PC connected to a communications network 30 such as the Internet via a modem and preferably an output printer 32A connected to the PC capable of outputting a print image on A1 size paper as the maximum size of the foldout sheet unfolded. A color ink-jet printer or color laser printer supporting color output is preferably used for the printer 32A.

Whether received image data and image-related information are properly received may be presented on a display for checkup before the received image is printed. In case the received image has a fault, the image is preferably corrected in the photofinishing laboratory shop 19 based on an instruction from the newspaper distribution depot D1.

In the newspaper distribution depot D1, a desired print image requested by the image source 12 is output (step 114). When the received image is output on a foldout sheet, the processed image is printed on a print sheet in accordance with the size of paper to be output specified in the output form column 305 of the image-related information template 300. The received image is output for example on A1-, A2- or A3-size paper. In this case, since a double-page spread of a regular daily newspaper delivered from a newspaper distribution depot corresponds to A1 size, the size of print paper used is preferably A1 which is the same as the size of the double-page of the newspaper, A2 as the size of paper obtained by folding the A1-size paper, or A3 as the size obtained by folding the A2-size paper. When a plurality of print sheets are specified in the output form column 305, a plurality of foldout sheets are printed. A single print sheet may include a plurality of print images and the print images may vary in size. The print image may be formed as a composite image including image information and text information (multi-tone image and line image including characters), or a line image formed from not image information but only text information (e.g., binary image).

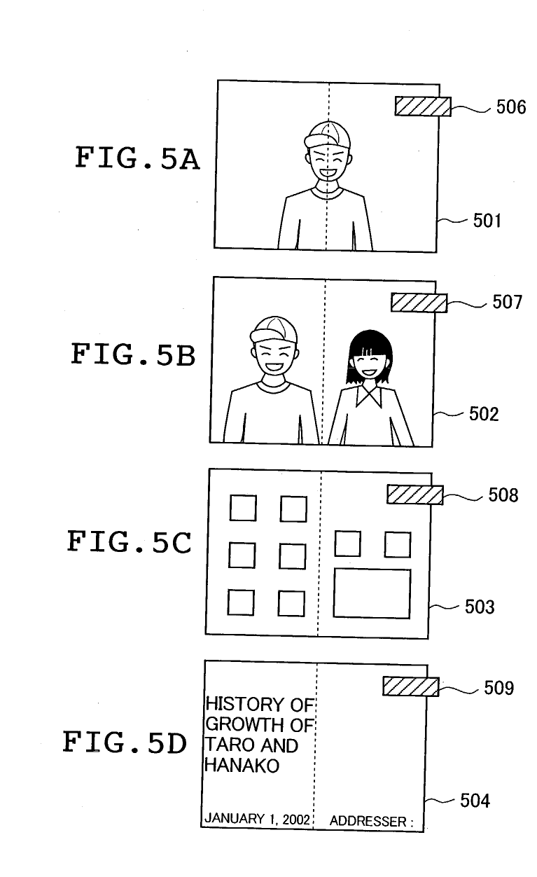

In particular, as shown in FIG. 5, a single print image may be output all over the double-page of the foldout sheet (FIG. 5A: A single portrait; 501). A single print image may be output on one side of the double-page of the foldout sheet and another on the other side (FIG. 5B: Portrait of two persons; 502). Further, a plurality of print images may be output in album form (FIG. 5C: Large/Small images are displayed in album form; 503). These images may be output on both sides on a sheet used as a foldout sheet. For example, text information shown in FIG. 5D may be printed on the rear side of a sheet where print images are output in album form in FIG. 5C (see reference numerals 503 and 504 in FIGS. 5C and 5D).

In the newspaper distribution depot Dl, information related to the image destination is stored onto an IC tag 506-509 as image destination identification means depending on the image destination described in the image destination column 303 (FIG. 4). This IC tag is attached to the print image just after it is output (step 116). An IC tag 506-509 is preferably attached to the print paper so that the IC tag 506-509 may readily be detected at the image destination. For example, an IC tag 506-509 is affixed to the print paper so that the tag will be partially extended off the edge of the print paper and easily detected, as shown in FIGS. 5A through 5D. Further, in the newspaper distribution depot D1, necessary information such as the address and name of the image destination is read from the IC tag 506-509 on a known IC tag reader and an instruction is issued to put the printed foldout sheet described above between the leaves of the newspaper to which the image destination specified by the image source 12 subscribes. The IC tag used here may be a known one, for example a “distribution label with IC tag” from TOPPAN FORMS CO., LTD. Data on an IC tag can be erased and data rewriting is possible, so that an IC tag may be reclaimed for recycling at the time when a desired print image has been delivered to the image destination 70-78.

Then, a foldout sheet where the image from the image source 12 is printed is put between the leaves of the newspaper to be delivered to the image destination stored on the IC tag 506-509. Thus, the desired print image is delivered to the predetermined image destination together with the newspaper delivered on the day corresponding to that in the image delivery date/time column 306 (FIG. 4). A known bar code and a known bar code reader may be used as means for identifying an image destination instead of an IC tag and an IC tag reader. In this case, a bar code to identify an image destination is printed on the sheet where a processed image is printed, when the processed image is output.

With the image print method and system as well as the image delivery method and system of the invention described hereinabove, a desired captured image captured by an image source is delivered as a desired print image to a desired image destination at a desired date and time. Additionally, the print image is readily and inexpensively delivered to the desired image destination by using an existing periodic delivery distribution service.

While a customer provides as an image source the image data of an image to be delivered and requests delivery of the image to a desired destination in the above embodiment, the customer may specify a desired site on a communications network so that an image will be downloaded by a digital photo printer from the specified site and delivered to an image destination specified by the customer. In this case, the information of the image to be downloaded is preferably the address information of the desired site specified on the image-related information template 300.

Next, a specific example using the image delivery system 10 shown in the above embodiment is explained.

In the following, a representative case is described in which, at the image source (customer) 12, the customer uses a digital still camera to acquire an image of a child of the customer (step 100). A print image of the child to show the growth of the child is delivered to the parents of the customer living at the image destination D73 on the birthday of the child by way of the image delivery method using the image delivery system 10.

A digital still camera is used to photoelectrically capture the portrait of the child (step 100). The captured digital image data is transferred from the digital still camera to the customer's PC equipped with a communications unit 14. In this example, the PC also serves as the communications unit 14. A picture of the customer's child may be taken by using a silver halide film, a developed negative film photoelectrically read on a transmission scanner and the image data transferred to the PC of interest. The scanner is then connected to the PC, where the shot image is displayed as a captured image. In this practice, text information such as “Jack on his four-year-old birthday, at Meiji Shrine” or “Betty, a new elementary schoolchild (Apr. 3, 2003)” may be added above the acquired digital image from a keyboard. Further, an original acquired digital image or a synthetic image with a digital image captured from the Internet may be specified as an image to be sent to a photofinishing laboratory shop.

Next, the above-mentioned image-related information is input from the keyboard of the PC as a file appended to the image to be sent. Necessary items of the image-related information are input on the image-related information template 300 (FIG. 4) from the keyboard of the PC. In this practice, by previously setting an image processing type displayed on the screen as required, an instruction of the image processing type is issued to the digital photo printer 18 of the photofinishing laboratory shop 19. For example, an image processing order may be made such as “isolate the portrait in the image” or “enhance blue color in the background” on a sentence input screen. A plurality of these image processing types may be instructed.

Next, captured image data to be sent is transmitted to the digital photo printer 19 of the photofinishing laboratory shop 19 together with the input image-related information from the communications unit 14 via the network 16 (step 102).

In the photofinishing laboratory shop 19, an image sent from the customer 12 is received and acquired by the communications network connecting section 52 (FIG. 2) via the communications network 16 (step 104) and stored into the memory section 48 (step 106). Image processing is performed on the acquired image data stored in accordance with the request for image processing by the image source 12 (step 108). Next, in the photofinishing laboratory shop 19, the acquired image and image-related information sent from the customer are sent via the communications network 30 to one of the newspaper distribution depots D1 through D3 equipped with the PCs or output printers 32A through 32C (step 110). In this practice, the periodic newspaper distribution depot closest to the address of the specified image destination (parents of the customer) is preferably selected based on the information specified in the image destination column 303 input to the image-related information template 300. In this example, it is assumed that the periodic newspaper distribution depot D2 in FIG. 1 is selected.

Next, in the periodic newspaper distribution depot D2, a processed image and image-related information sent from the photofinishing laboratory shop 19 are received (step 112) and the processed image and the image-related information are stored into a storage unit (not shown) as required. The image destination 303 and the specified image delivery date/time 306 when the print image is to be delivered together with newspaper are checked by the template 300. Necessary information is then written onto an IC tag (506-509) by using an IC tag data writer. On the sheet of a newspaper of a specified size or on a foldout sheet is output a print image via an output printer 32B provided in the newspaper distribution depot D2 (step 114).

Next, in the newspaper distribution depot D2, the IC tag is attached on the print image sheet where a desired image is printed by way of the output printer 32B (step 116). The foldout sheet where the IC tag is attached is preferably discriminated from the newspaper. Necessary image-related information stored on the IC tag is read by the data reader before the newspaper is delivered. For example, information necessary for delivery including the image destination 70-78, delivery date/time, and morning paper or evening paper is acquired on a PC screen from the IC tag reader. The newspaper where is sandwiched a foldout sheet bearing a print image requested by the customer 12 is delivered to for example the image destination D73.

In this way, a print image can be easily delivered from the image source 12 to the desired image destination 73 even when the destination is a person who does not own a PC. Similarly, a print image can be easily delivered to a person who owns a PC but is not good at operating the PC or who owns a PC but not a printer.

Further, by using a foldout sheet put between the leaves of a newspaper, it is possible to deliver a maximum of A1 wide print image and deliver a plurality of print images in a wide, flexible or random arrangement in a double-page spread state. A print image exceeding the A1 size can be created depending on the printing capability of the output printer 32B. Even when an image is printed on an A0-or-larger paper, the image is delivered by properly folding the sheet within the size of a newspaper.

By using a foldout sheet in this way, it is possible to readily deliver a desired print image without using space such as a newspaper ad. A photofinishing laboratory shop can provide an advertising agency with an ad service by using for example the margin of a foldout sheet in a newspaper where a print image is output.

The customer as the image source 12 has only to send a desired image to the photofinishing laboratory shop 19 closest to its address or location when it wishes to deliver a desired image as a print image to a farthest destination the newspaper delivery service can reach by utilizing the network of newspaper distribution depots across the country. While the image source is separate from the image destination in the above embodiments and examples, it is possible to request a service for the requester himself/herself by specifying the image source as an image destination as well.

Further, an IC tag is attached to the print image paper to be supplied to the image destination A-I (70-78). Thus, it is easily recognized at the image destination A-I (70-78) that the print image sheet is a printed matter different from other foldout sheets.

While the image destination is an individual in the above embodiments and examples, the image destination 70-78 may be for example an area, not an individual. For example, it is possible to specify a real estate agent as an image source (customer) 12 in FIG. 1 and deliver desired image information and/or text information in the form of a print image output as an accompaniment for a newspaper as periodic delivery to all the newspaper subscribers in the area limited in terms of a real estate property for sale by the real estate agency.

In this case, the image destination is not limited to an individual so that only the delivery area and the number of homes to which delivery is to be offered must be identified. There is no need to attach an IC tag to identify the image destination for ease of delivery as in the foregoing specific example. Thus, it is possible to skip the process for attaching the image destination identification means (step 116) as shown in FIG. 3.

It is also possible to deliver a print image to the destination while narrowing down the target from an indefinite number of people considering the age bracket, ratio of males to females, number or ratio of grown-ups and children, and nature and climate of the locality of the residents.

While the above embodiment is an example of the invention and the following modifications and amendments may be made as appropriate based on the technical items described in the claims of the invention.

While the print image is output on the foldout paper in a newspaper as periodic delivery in the foregoing embodiments, the periodic delivery may be a subscribed magazine or milk purchased on a regular basis. The invention may be a service which always supplies delivery to customers nationwide in a regular distribution process. For example, in case periodic deliver is a matter in a container such as milk, the image requested by the image source (customer) may be printed on the container itself, or the print image may be attached on the container and delivered to the image destination.

According to the invention, an image source may deliver a desired image to an image destination that has previously entered into a contract of providing for example a customer column on a newspaper sheet or magazine sheet. That is, it is possible to output a delivery-requested image as a print image in a customer column provided as part of delivery. As a result, the image destination can use the customer column on a newspaper sheet or magazine sheet to enjoy an image delivery service.

The invention supports a print order of a delivered image by an image destination. This is to support a case where a person at the image destination requests to make more prints and/or quality prints of a delivered print image. In this case, the IC tag attached to the print image in a periodic delivery distribution depot (newspaper distribution depot) D1 for example is removed by the person at the image destination. The person describes in the additional print order column of the IC tag an order such as “Make three more copies of the print image on . . . ” or “Output the print image on . . . using ink-jet paper.” The IC tag is collected for example by a newspaper carrier at the newspaper distribution depot D1. The newspaper distribution depot D1 requests the photofinishing laboratory shop 19 to supply the image data stored. When a high quality print is requested, appropriate image processing may be made by the photofinishing laboratory shop 19 as required and a desired image printed on high quality print paper in the photofinishing laboratory shop 19.

A periodic delivery (newspaper etc.) distribution depot may request a photofinishing laboratory shop or a photo studio which is the nearest to the delivery destination (image destination) to print the image of interest, as required. It is desirable that image data are stored in a recording device (memory, hard disk, image data recording medium, and so forth) at the distribution depot (or in the image processing center) for a predetermined period from the time of delivery request in preparation for a reorder of printing. Such measures have an effect that repeated acquirement of image data can be eliminated when a reorder is received.

The invention also supports a case where a print image is delivered as an ad to the image destination A-I (70-78) in accordance with the clientele of the image source (customer) 12. In this practice, in case the clientele can be classified into people in late middle age, people in middle age and “new family generation” for a same department store ad, an ad or print image covering the article lineup to suit a specific clientele can be delivered. The information on the clienteles is written onto an IC tag. A tag reader is used to determine the clienteles and sorting is made when the foldout sheet bearing the print image is sandwiched in a newspaper before delivery. An ad or image to suit a specific clientele may be printed on an ad page of a magazine periodically delivered, such as a mail-order magazine, and delivered to the image destination A-I (70-78).

In the case of such a distribution depot as a newspaper distribution depot, it is preferred that the order of printing or the order of putting foldouts between the leaves of newspaper is controlled based on the delivery order on respective delivery routes. Such measures are so effective that the delivery can be carried out more efficiently and misdelivery can be prevented.

Now described are the image delivery method and image delivery system of the invention, that are intended for the delivery of a print image output in the image print method and image print system of the invention to an image destination as part of a periodic delivery or as an accompaniment for the periodic delivery.

The image delivery method and image delivery system of the invention are provided for the purpose of preventing misdelivery of print images and periodic deliveries or assisting the work of carriers.

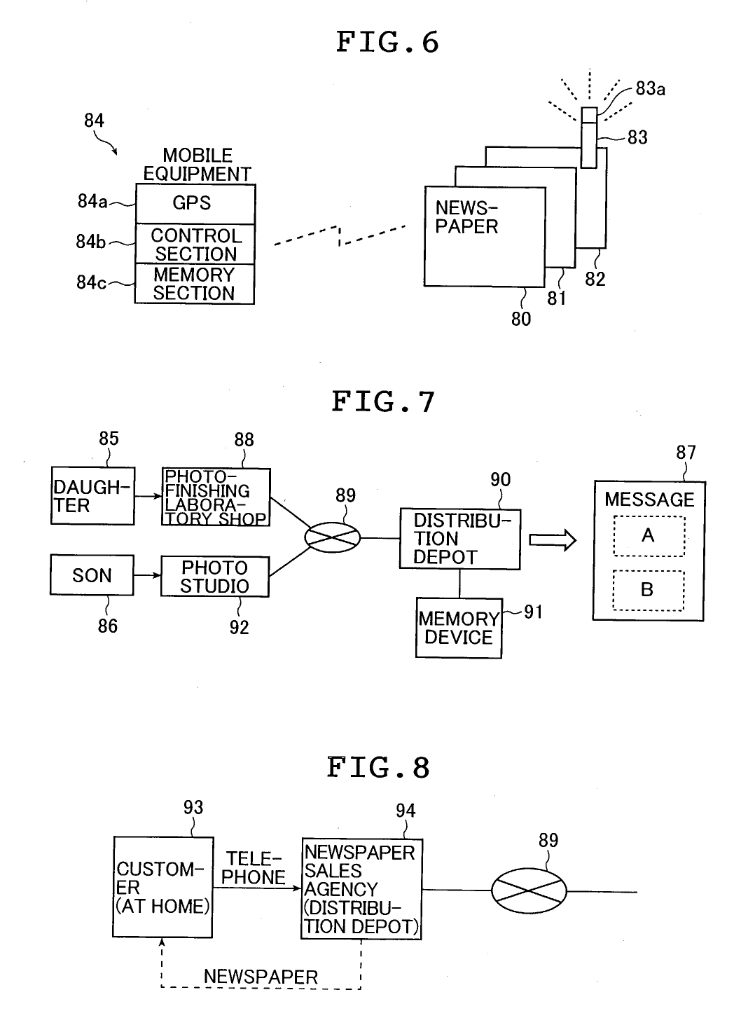

In a first embodiment as shown in FIG. 6, a light-emitting device (EL element, LED, and so forth) 83a is mounted in advance on the tip of an IC tag 83 provided on paper for printing 82 having the print image of interest output thereon which is to be delivered together with newspaper 80 and a foldout sheet 81. The IC tag 83 with the light-emitting device 83a may be adhered or attached to a periodic delivery such as the newspaper 80.

At the same time, a carrier of print images and periodic deliveries takes a mobile equipment 84 with the GPS function along. The mobile equipment 84 comprises a GPS function section 84a, a control section 84b, and a memory section 84c. The carrier may also take a mobile equipment of a navigation-system type for guiding a user to a goal, such as a car navigation system, instead of the mobile equipment 84 with the GPS function. Alternatively, the carrier takes no such equipment along but a vehicle for transporting periodic deliveries may have a car navigation system built therein or an onboard equipment of a navigation-system type mounted thereon or on board thereof.

In the mobile equipment 84 taken by the carrier or the onboard equipment built in, mounted on, or on board of the vehicle etc., the identification number of the IC tag 83 and the information on the delivery destination are recorded together as a set in the memory section 84c. The information on the delivery destination may include, apart from the address of the delivery destination as an example, the name of the building in which the delivery destination is present, the name of the delivery destination, or a combination thereof.

When the carrier has arrived at the delivery destination as the goal utilizing the mobile equipment 84 or the onboard equipment, an instruction signal is transmitted from the control section 84b of the mobile equipment 84 or a control section of the onboard equipment to a plurality of deliveries (more accurately to IC tags thereof), with the signal causing the light-emitting device 83a of the IC tag 83 adhered or attached to the relevant delivery (print image and periodic delivery) to emit light.

The light-emitting device 83a on the tip of the IC tag 83 of the relevant delivery (the newspaper 80 as a periodic delivery, the foldout sheet 81 and the print image 82) thus emits light and, as a result, the carrier can be prevented from misdelivery and smoothly carry out his work of delivery.

In a second embodiment, a periodic delivery receiver of each delivery destination, for example, a mailbox of each home or building, may have an IC tag attached thereto, in which one or more kinds of information including the address data, data on the name of the building as a delivery destination, and data on the name of the delivery destination are recorded.

In this embodiment, the mobile equipment taken by the carrier is provided with the function of IC tag reader instead of the GPS function.

When the carrier has arrived at the delivery destination as the goal, the mobile equipment reads the address data or the like from the receiver or mailbox and transmit an instruction signal to a plurality of deliveries, the signal causing the light-emitting device of the IC tag attached to the relevant delivery (print image and periodic delivery) to emit light.

The light-emitting device on the tip of the IC tag of the relevant delivery (print image and periodic delivery) thus emits light and, as a result, the carrier can be prevented from misdelivery and smoothly carry out his work of delivery.

In yet another embodiment, an IC tag reader may be set on a mailbox of each delivery destination or each home.

In this embodiment, an acoustic or visual alarm indicating “inconformity” is generated if the information on delivery destination in the IC tag adhered to the delivery is not in conformity with the address.

As a result, the carrier can be prevented from misdelivery and smoothly carry out his work of delivery.

It is also possible for the purpose of preventing misdelivery or assisting the work of a carrier to set forth the address of the delivery destination on a map based on the information on delivery destination in the IC tag adhered to the delivery in an embodiment other than the above, or in any of the above embodiments.

In the image print method and system as well as the image delivery method and system of the invention, images received from a plurality of transmitters for the delivery to one and the same customer (delivery destination) may automatically be subjected to a layout edition in the server (buffer) of the distribution depot such that they are arranged in one print (on one sheet of paper).

For instance, as shown in FIG. 7, an image A transmitted from a daughter 85 in a family who lives in one district and an image B transmitted from a son 86 in the family who lives in another district may be arranged collectively on one and the same sheet of paper 87. Specifically, the image data on the image A brought to a photofinishing, laboratory shop 88 by the daughter 85 is transmitted from the photofinishing laboratory shop 88 to a distribution depot 90 via a communications network 89 and stored in a storage device 91 of the depot, while the image data on the image B brought to a photo studio 92 by the son 86 is transmitted from the photo studio 92 to the distribution depot 90 via the communications network 89 and stored in a storage device 91 of the depot. In this way, the image A transmitted from the daughter 85 and the image B transmitted from the son 86, both stored in the storage device 91, may be subjected to the layout edition and output onto one and the same sheet of paper 87 so as to produce one print.

In that case, characters may be printed instead of, or in addition to images. For instance, a picture of the family and a message “Congratulations on your birthday !” may be printed on one sheet of paper for printing.

It is further possible to collect ads from a plurality of traders into one page as printed images.

Image data and other data may be accumulated in a server of a distribution depot for a given period for every customer (delivery destination) and the data thus accumulated may collectively be subjected to the layout edition in an automatic manner so as to output them in one print (on one sheet of paper).

For example, if the date of image delivery is not specified with respect to the received data, data for one week may be subjected to the layout edition such that they are output collectively on one page or sheet. Moreover, it is possible to realize a layout in which data are sorted according to their transmitters (image sources).

In the two examples as above, various images or various kinds of information, which have been supplied separately in principle, are sorted and united with one another so that they are easier to recognize. For this reason, the print produced by outputting a plurality of images on one sheet of paper as a result of the layout edition is suitable for the use as a standing matter.

In the present invention, an extra request for delivery may also be supported. In that case, for instance, a photofinishing laboratory shop communicates with a plurality of distribution depots and, if the requested delivery can not be made at a first distribution depot, a second candidate distribution depot will be requested to make the delivery. Preferably, such requests are automatically carried out.

As an example: the distribution depot D1 that is the nearest to the delivery destination is initially requested the delivery and, if there is no carrier at the depot D1 who can make the delivery, the distribution depot D2 that is the second nearest will be requested the delivery. If there is no carrier at the distribution depot D2 also who can make the delivery, the distribution depot that is the third nearest will be requested the delivery and such a request may be repeated until the distribution depot is found out where the delivery can be carried out.

As for the accounting for the image delivery service according to the present invention, the service may be charged to the transmitter (image source) with the amount being indicated to him or the charge for the service may be fixed. Alternatively, the charge for the service may be added to the charge for the delivery to which the receiver of the image subscribes or, again, the charge for the service may be fixed.

In the present invention, various forms of service can be presented.

For instance, a print order accepting apparatus of a network-connected type, to which a transmitting function is imparted, may be used instead of requesting an image delivery to a photofinishing laboratory shop. In another case, an image may be transmitted by using a distribution depot retrieval service on a network from a home PC of the transmitter.

In the case where an access destination on the Internet is set forth in a TV program or an article of a magazine or newspaper for the purpose of making the contents of the program or the article available to the audience or the readers, for example, a newspaper subscriber as the customer of the image printing and image delivery service according to the present invention may show the access destination to the newspaper publisher (a newspaper sales agency also acceptable) so as to obtain the service.

In this respect, the customer may request an image delivery by reading off the access destination over the telephone, or by sending by fax or handing (to the newspaper carrier) a copy of the article with the relevant part surrounded with a circle, or again, by reading off the channel number of the television station which put the program on the air and the program title (and the air time) over the telephone.

On the other hand, the newspaper publisher may print the image on a foldout sheet in combination with the information on the access destination to thereby output a printed image according to the request for delivery.

When the access destination is shown, the image data and other data can be downloaded directly from the site of the access destination. When the TV channel number and the program title are shown, reference may be made to the television station so as to request it to give the access destination for the relevant ad and so forth. Then the image data and other data can be downloaded from the site of the access destination as given.

If the customer wants to get information on the Internet which has a hierarchical structure or a link, he can read the statement of the information on the print which will be delivered next time by checking the input area.

In this respect, if a plurality of parts of the statement are designated, they are arranged collectively on one and the same sheet of paper. The parts exceeding the capacity of the sheet, if any, may be output in the print to be delivered next time.

The present invention can be utilized as a substitution of the dictionary or map retrieval function.

As shown in FIG. 8, a customer (at home) 93 initially calls a special telephone number of a newspaper sales agency (distribution depot) 94 and speaks the word whose meaning he wants to know for the voice input over the telephone. Response may be brought based on the voice recognition.

Next, the dictionary data representing the meaning of the word is retrieved from a database by the server (buffer) of the sales agency and printed on a foldout sheet to be delivered to the customer. Thus, the printed dictionary data is delivered from the sales agency 94 to the customer 93 together with newspaper.

Such processes as the data retrieval and the printing as above are preferably performed in a full-automatic manner.

In the present invention, the result of retrieval may be given on the day next to the day of request for delivery, or every two to six days collectively, or the like.

The present invention can further be utilized as a substitution of the e-mail or diary function.

In this respect, the contents of the speech over the telephone are documented by the server of a photofinishing laboratory shop or a distribution depot based on the voice recognition and printed on a foldout sheet to be put between the leaves of newspaper.

Preferably, the server of a photofinishing laboratory shop is caused to relay voice data also.

Then, for example, one can send a voice mail to his/her aged parent who is hard of hearing (it is preferred that the contents of the mail appear on the next-day newspaper), or a mail can be recorded on both an answering machine and newspaper.

For those who find keeping a diary burdensome, the contents input in parts over the telephone are assembled by day and delivered together with the newspaper of a new-year version.

According to the present invention as the above substitutions, information on the Internet and so forth can be readily obtained together with newspaper by even a person lacking for a PC, an Internet-connected environment, or a facsimile.

Besides, instead of providing the IC tag with the light-omitting device, the IC tag may be provided with a electronic paper and the mechanism that makes the density or the color of the electronic paper changeable and the change of the density or the color visible may be used.

As detailed hereinabove, according to the first and second aspects of the invention, it is possible to provide an image print method and an image print system whereby a desired processed image which has undergone image processing is sent as a printed image to a desired image destination, via a communications network, even when the destination is a person who does not own a PC or a printer, or who owns a PC and a printer but is not good at operating the PC and the printer.

Moreover, according to the third and fourth aspects of the invention, it is possible to provide an image delivery method and an image delivery system in which, apart from obtaining the above effects of the first and second aspects, such a delivery as a periodic delivery including a printed image can be prevented from misdelivery and the work of delivery can be carried out smoothly.

What is claimed is:

1. An image print method comprising:
an image processing step of performing image processing on image data acquired, in accordance with information on the image processing based on a request from a customer;
an image sending step of sending the image data subjected to the image processing to a periodic distribution center which distributes a plurality of periodic deliveries via communication circuits together with information on an image destination based on the request from the customer; and
a print image outputting step of outputting on a sheet a print image corresponding to the processed image data sent to the periodic distribution center as part of a periodic delivery destined for a destination conforming to the image destination specified by said information on the image destination based on the request from the customer or as an accompaniment for said periodic delivery.

2. The image print method according to claim 1, wherein said request from the customer is destined for an image processing center equipped with an image processor connected via said communication circuits.

3. The image print method according to claim 2, wherein the image data acquired by said image processor is at least one of image data provided together with the request from the customer, image data acquired by reading image provided together with the request from the customer, and image data downloaded from a network connected via the communication circuits in accordance with an instruction from the customer.

4. The image print method according to claim 1, wherein said periodic delivery is printed matter regularly delivered from said periodic distribution center to said destination.

5. The image print method according to claim 1, wherein said sheet where the print image is output or said periodic delivery is provided with destination identifying means having image destination information specified by said information on the image destination based on the request from the customer.

6. The image print system according to claim 5, wherein said destination identifying means is an IC (integrated circuit) tag which stores said image destination information.

7. An image print system comprising an image processor and an output printer which are interconnected via communication circuits,
wherein said image processor performs image processing on image data acquired, in accordance with information on the image processing based on a request from a customer and sends the image data subjected to the image processing to the output printer installed in a periodic distribution center which distributes a plurality of periodic deliveries together with information on an image destination based on the request from the customer and
wherein said output printer outputs on a sheet a print image corresponding to said image data received from said image processor after the image processing has been performed, as part of a periodic delivery destined for a destination conforming to the image destination specified by said information on the image destination based on the request from the customer or as an accompaniment for said periodic delivery.

8. The image print system according to claim 7, wherein the image data acquired by said image processor is at least one of image data provided together with the request from the customer, read image data acquired by reading an original image provided together with the request from the customer, and image data downloaded from a network connected via the communication circuits in accordance with an instruction from the customer.

9. The image print system according to claim 7, wherein said image processor is installed in an image processing center and said request from the customer is destined for said image processing center.

10. The image print system according to claim 7, wherein said periodic delivery is printed matter regularly delivered from said periodic distribution center to said destination.

11. The image print system according to claim 7, wherein said sheet where the print image is output or said periodic delivery is provided with destination identifying means having image destination information specified by said information on the image destination based on the request from the customer.

12. The image print system according to claim 11, wherein said destination identifying means is an IC (integrated circuit) tag which stores said image destination information.

13. An image delivery method by which a print image output by an image print method is delivered to a destination of a periodic delivery conforming to an image destination specified by information on the image destination based on a request from a customer as part of said periodic delivery destined for said destination or as an accompaniment for said periodic delivery,
wherein said image print method comprises:
an image processing step of performing image processing on image data acquired, in accordance with information on the image processing based on the request from the customer;
an image sending step of sending the image data subjected to the image processing to a periodic distribution center which distributes a plurality of periodic deliveries via communication circuits together with the information on the image destination based on the request from the customer; and
a print image outputting step of outputting on a sheet said print image corresponding to the processed image data sent to the periodic distribution center as the part of the periodic delivery destined for said destination or as the accompaniment for said periodic delivery,
said image delivery method, comprising:
a step of providing a light-emitting device at an end of a first IC tag which is attached to the sheet having said print image output thereon or to said periodic delivery including said sheet as the part thereof or as the accompaniment therefor, and which has image destination information specified by the information on the image destination based on the request from the customer;
a step of setting an identification number of said first IC tag and said destination in a navigation system mounted on or on board of a vehicle for use in distributing said plurality of periodic deliveries from the periodic distribution center to a plurality of destinations or to onboard equipment with a GPS (Global Positioning System) function possessed by a carrier distributing said plurality of periodic deliveries;
a step of transmitting a light emission signal for allowing said first IC tag to emit light in accordance with the set identification number from said navigation system or said onboard equipment with the GPS function to said plurality of periodic deliveries when said vehicle or said carrier arrives at said destination making use of said navigation system or said onboard equipment with the GPS function; and
a step of allowing said light-emitting device of said first IC tag which has an identification number conforming to the set identification number to emit light.

14. An image delivery method by which a print image output by an image print method is delivered to a destination of a periodic delivery conforming to an image destination specified by information on the image destination based on a request from a customer as part of said periodic delivery destined for said destination or as an accompaniment for said periodic delivery,
wherein said image print method comprises:
an image processing step of performing image processing on image data acquired, in accordance with information on the image processing based on the request from the customer;
an image sending step of sending the image data subjected to the image processing to a periodic distribution center which distributes a plurality of periodic deliveries via communication circuits together with the information on the image destination based on the request from the customer; and
a print image outputting step of outputting on a sheet said print image corresponding to the processed image data sent to the periodic distribution center as the part of the periodic delivery destined for said destination or as the accompaniment for said periodic delivery,
said image delivery method, comprising:
a step of providing a light-emitting device at an end of a first IC tag which is attached to the sheet having said print image output thereon or to said periodic delivery including this sheet as the part thereof or as the accompaniment therefor, and which has image destination information specified by the information on the image destination based on the request from the customer;
a step of attaching to a receiver of said periodic delivery in said destination, a second IC tag in which information on said destination is stored;
a step of reading the information on the destination stored in said second IC tag by onboard equipment possessed by a carrier and having an IC tag reader function of reading information stored in an IC tag, when the carrier distributing said plurality of periodic deliveries from the periodic distribution center to a plurality of destinations, thereby transmitting a light emission signal for allowing said first IC tag to emit light from said onboard equipment to said plurality of periodic deliveries in accordance with the information on the destination read by said onboard equipment; and
a step of allowing said light-emitting device of said first IC tag which has the image destination information conforming to the information on the destination to emit light.

15. An image delivery method by which a print image output by an image print method is delivered to a destination of a periodic delivery conforming to an image destination specified by information on the image destination based on a request from a customer as part of said periodic delivery destined for said destination or as an accompaniment for said periodic delivery,
wherein said image print method comprises:
an image processing step of performing image processing on image data acquired, in accordance with information on the image processing based on the request from the customer;
an image sending step of sending the image data subjected to the image processing to a periodic distribution center which distributes a plurality of periodic deliveries via communication circuits together with the information on the image destination based on the request from the customer; and
a print image outputting step of outputting on a sheet said print image corresponding to the processed image data sent to the periodic distribution center as the part of the periodic delivery destined for said destination or as the accompaniment for said periodic delivery,
said image delivery method, comprising:
a step of attaching to a receiver of said periodic delivery in said destination, an IC tag reader which reads information stored in an IC tag and in which the information on the destination is set;
a step of reading with said IC tag reader, image destination information stored in a first IC tag which is attached to said periodic delivery to be distributed to said destination or to the sheet which is distributed as the part of or the accompaniment for said periodic delivery and on which said print image is output, and which has said image destination information specified by the information on the image destination based on the request from the customer; and
a step of announcing inconformity by voice or visual display when the information on the destination set by said IC tag reader does not conform to said image destination information that said IC tag reader read from said first IC tag.

16. An image delivery system which delivers a print image to a destination of a periodic delivery conforming to an image destination specified by information on an image destination based on a request from a customer as part of said periodic delivery destined for the destination or as an accompaniment for said periodic delivery, comprising:
an image print system for outputting said print image, said image print system comprising an image processor and an output printer which are interconnected via communication circuits, wherein said image processor performs image processing on image data acquired, in accordance with the information on the image processing based on the request from the customer and sends the image data subjected to the image processing to the output printer installed in a periodic distribution center which distributes a plurality of periodic deliveries together with the information on the image destination based on the request from the customer, and wherein said output printer outputs on a sheet said print image corresponding to said image data received from said image processor after the image processing has been performed, as the part of the periodic delivery destined for the destination or as the accompaniment for said periodic delivery;
a first IC tag which is attached to the sheet having said print image output thereon or to said periodic delivery including said sheet as the part thereof or as the accompaniment therefor, which has image destination information specified by the information on the image destination based on the request from the customer and which has a light-emitting device attached to an end thereof; and
a navigation system mounted on or on board of a vehicle for distributing said plurality of periodic deliveries from the periodic distribution center to a plurality of destinations or onboard equipment with a GPS function that a carrier distributing said plurality of periodic deliveries possesses, said navigation system or said onboard equipment previously setting an identification number of said first IC tag and said destination,
wherein, when said vehicle or said carrier arrives at said destination making use of said navigation system or said onboard equipment, a light emission signal for allowing said first IC tag to emit light is transmitted in accordance with the set identification number from said navigation system or said onboard equipment to said plurality of periodic deliveries, whereby said light-emitting device of said first IC tag whose identification number conforms to the set identification number emits light.

17. An image delivery system which delivers a print image to a destination of a periodic delivery conforming to an image destination specified by information on an image destination based on a request from a customer as part of said periodic delivery destined for the destination or as an accompaniment for said periodic delivery, comprising:
an image print system for outputting said print image, said image print system comprising an image processor and an output printer which are interconnected via communication circuits, wherein said image processor performs image processing on image data acquired, in accordance with the information on the image processing based on the request from the customer and sends the image data subjected to the image processing to the output printer installed in a periodic distribution center which distributes a plurality of periodic deliveries together with the information on the image destination based on the request from the customer, and wherein said output printer outputs on a sheet said print image corresponding to said image data received from said image processor after the image processing has been performed, as the part of the periodic delivery destined for the destination or as the accompaniment for said periodic delivery;
a first IC tag which is attached to the sheet having said print image output thereon or to said periodic delivery including said sheet as the part thereof or as the accompaniment therefor, which has image destination information specified by the information on the image destination based on the request from the customer and which has a light-emitting device attached to an end thereof;
a second IC tag which is attached to a receiver of said periodic delivery in said destination and in which the information on said destination is stored; and
onboard equipment possessed by a carrier and having an IC tag reader function of reading information stored in an IC tag when the carrier distributing said plurality of periodic deliveries from the periodic distribution center to a plurality of destinations,
wherein the information on the destination stored in said second IC tag is read,
wherein a light emission signal for allowing said first IC tag to emit light is transmitted from said onboard equipment to said plurality of periodic deliveries in accordance with the information on the destination read by said onboard equipment, and
wherein said light-emitting device of said first IC tag having the image destination information conforming to the read information on the destination is allowed to emit light.

18. An image delivery system which delivers a print image to a destination of a periodic delivery conforming to an image destination specified by information on an image destination based on a request from a customer as part of said periodic delivery destined for the destination or as an accompaniment for said periodic delivery, comprising:
an image print system for outputting said print image, said image print system comprising an image processor and an output printer which are interconnected via communication circuits, wherein said image processor performs image processing on image data acquired, in accordance with the information on the image processing based on the request from the customer and sends the image data subjected to the image processing to the output printer installed in a periodic distribution center which distributes a plurality of periodic deliveries together with the information on the image destination based on the request from the customer, and wherein said output printer outputs on a sheet said print image corresponding to said image data received from said image processor after the image processing has been performed, as the part of the periodic delivery destined for the destination or as the accompaniment for said periodic delivery;
a first IC tag which is attached to said sheet having said print image output thereon or to said periodic delivery including said sheet as the part thereof or as the accompaniment therefor and which has image destination information specified by the information on the image destination based on the request from the customer; and
an IC tag reader which is placed on a receiver of said periodic delivery in said destination, which reads information stored in an IC tag and which sets the information on said destination,
wherein, when a carrier distributing said plurality of periodic deliveries from the periodic distribution center to a plurality of destinations arrives at said destination, said IC tag reader is used to read the information on said destination stored in said first IC tag which is attached to said periodic delivery to be distributed to said destination or to said sheet which is distributed as the part of or the accompaniment for said periodic delivery and on which said print image is output, and
wherein inconformity is announced by voice or visual display when the information on the destination set by said IC tag reader does not conform to said image destination information that said IC tag reader read from said first IC tag.
